(19) United States
(12) Patent Application Publication
(10) Pub. No.: US 2026/0079278 A1
(43) Pub. Date: Mar. 19, 2026

(54) PREDICTING MEMBRANE STIFFNESS AND ESTIMATING FORMATION MOBILITY USING ACOUSTIC STONELEY WAVES

(71) Applicant: Schlumberger Technology Corporation, Sugar Land, TX (US)

(72) Inventors: Mohamed Nabeel Saif, Dhahran (SA); Turki Allugman, Dhahran (SA); Wael Abdallah; Olivier Sindt, Cambridge (GB); Khaled Saleh, Dhahran (SA)

(21) Appl. No.: 18/887,676

(22) Filed: Sep. 17, 2024

(51) Int. Cl. G01V 1/50; E21B 7/04; E21B 47/06; E21B 49/00

(52) U.S. Cl. CPC G01V 1/50; E21B 7/04; E21B 47/06; E21B 49/00; E21B 2200/20; E21B 2200/22; G01V 2210/624

(57) ABSTRACT

The present disclosure relates to systems and methods for predicting membrane stiffness and providing a formation mobility estimation using acoustic Stoneley waves. The systems and methods use machine learning models for predicting membrane stiffness of a reservoir and estimating formation mobility using the predicted membrane stiffness and Stoneley waves. The systems and methods use the predicted membrane stiffness and mobility estimations to provide insights into reservoir properties and drilling conditions.

### BACKGROUND

In the landscape of reservoir evaluation, a comprehensive understanding of parameters, such as, porosity and permeability is traditionally crucial to the reservoir evaluation. Despite statistical correlations between permeability and porosity, the reliability of such relationships is contingent upon various rock properties. Technological advancements in petrophysics have not entirely resolved the challenge of obtaining continuous formation permeability profiles.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes obtaining reservoir measurements of a reservoir. The method includes using, a machine learning model, to estimate membrane stiffness values of the reservoir using the reservoir measurements. The method includes determining, using the machine learning model, a formation mobility of the reservoir using the membrane stiffness values. The method includes outputting the formation mobility and the membrane stiffness values of the reservoir.

Some implementations relate to a system. The system includes a memory to store data and instructions; and a processor operable to communicate with the memory, wherein the processor is operable to: obtain reservoir measurements of a reservoir; use, a machine learning model, to estimate membrane stiffness values of the reservoir using the reservoir measurements; determine, using the machine learning model, a formation mobility of the reservoir using the membrane stiffness values; and output the formation mobility and the membrane stiffness values of the reservoir.

Some implementations relate to a computer-readable storage medium including instructions that, when executed by a processor, cause the processor to: obtain reservoir measurements of a reservoir; use, a machine learning model, to estimate membrane stiffness values of the reservoir using the reservoir measurements; determine, using the machine learning model, a formation mobility of the reservoir using the membrane stiffness values; and output the formation mobility and the membrane stiffness values of the reservoir.

Some implementations relate to a method. The method includes generating sets of Stoneley mobilities using randomly generated membrane stiffness values within an expected range. The method includes training a machine learning model for each sample point within a reservoir to establish a relationship between the membrane stiffness values and Stoneley mobilities. The method includes calculating, using the trained machine learning model, new membrane stiffness values at a depth for each formation pressure test that obtained the Stoneley mobilities. The method includes inverting, using the trained machine learning model, the membrane stiffness values from the Stoneley mobilities. The method includes outputting the membrane stiffness values.

Some implementations relate to a system. The system includes a memory to store data and instructions; and a processor operable to communicate with the memory, wherein the processor is operable to: generate sets of Stoneley mobilities using randomly generated membrane stiffness values within an expected range; train a machine learning model for each sample point within a reservoir to establish a relationship between the membrane stiffness values and Stoneley mobilities; calculate, using the trained machine learning model, new membrane stiffness values at a depth for each formation pressure test that obtained the Stoneley mobilities; invert, using the trained machine learning model, the membrane stiffness values from the Stoneley mobilities; and output the membrane stiffness values.

Some implementations relate to a computer-readable storage medium including instructions that, when executed by a processor, cause the processor to: generate sets of Stoneley mobilities using randomly generated membrane stiffness values within an expected range; train a machine learning model for each sample point within a reservoir to establish a relationship between the membrane stiffness values and Stoneley mobilities; calculate, using the trained machine learning model, new membrane stiffness values at a depth for each formation pressure test that obtained the Stoneley mobilities; invert, using the trained machine learning model, the membrane stiffness values from the Stoneley mobilities; and output the membrane stiffness values.

Some implementations relate to a method. The method includes predicting, using a trained machine learning model, membrane stiffness values for a reservoir. The method includes estimating, by the trained machine learning model, formation mobility of the reservoir using the membrane stiffness values and Stoneley mobility. The method includes displaying, on a user interface of a device, the formation mobility and the membrane stiffness values.

Some implementations relate to a system. The system includes a memory to store data and instructions; and a processor operable to communicate with the memory, wherein the processor is operable to: predict, using a trained machine learning model, membrane stiffness values for a reservoir; estimate, by the trained machine learning model, formation mobility of the reservoir using the membrane stiffness values and Stoneley mobility; and display, on a user interface of a device, the formation mobility and the membrane stiffness values.

Some implementations relate to a computer-readable storage medium including instructions that, when executed by a processor, cause the processor to: predict, using a trained machine learning model, membrane stiffness values for a reservoir; estimate, by the trained machine learning model, formation mobility of the reservoir using the membrane stiffness values and Stoneley mobility; and display, on a user interface of a device, the formation mobility and the membrane stiffness values.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for predicting membrane stiffness and estimating formation mobility in accordance with implementations of the present disclosure.

FIG. 2 illustrates an example method of processing reservoir measurements in accordance with implementations of the present disclosure.

FIG. 3 illustrates an example method for predicting membrane stiffness in accordance with implementations of the present disclosure.

FIG. 4 illustrates an example method for predicting membrane stiffness and estimating formation mobility in accordance with implementations of the present disclosure.

FIG. 5 illustrates an example method for evaluating formation properties in accordance with implementations of the present disclosure.

FIG. 6 illustrates components that may be included within a computer system in accordance with implementations of the present disclosure.

### DETAILED DESCRIPTION

This disclosure generally relates to evaluating formation properties. In the landscape of reservoir evaluation, a comprehensive understanding of parameters, such as, porosity and permeability is traditionally crucial to the reservoir evaluation. Despite statistical correlations between permeability and porosity, the reliability of such relationships is contingent upon various rock properties.

Existing solutions correlated formation conductivity with porosity due to the limitations in acquiring ongoing mobility data. To surmount this challenge, formation testing tools are commonly employed, albeit providing discrete data points and incurring high costs. Various methods, including NMR pore size distribution and acoustic Stoneley waveform inversion, have been proposed to derive mobility or permeability logs.

The Stoneley wave, named after Robert Stoneley, travels along solid-liquid and solid-solid interfaces, exhibiting sensitivity to fluid mobility near the wellbore formation. Existing solutions use the borehole Stoneley waves to estimate permeability. At low frequencies, such as 500 Hz, Stoneley waves mimic tube waves, demonstrating compression effects. Efforts to establish a robust methodology for evaluating mobility from Stoneley waveforms include theoretical models based on a Biot poro-elastic (PORELAS) theory, refining a PORELAS model to include parameters affecting Stoneley waves, such as, mud cake, represented by elastic membrane stiffness. Other existing solutions propose a multi-frequency inversion method integrating mud acoustic properties and Stoneley wave behavior.

Despite these advancements, realizing Stoneley-based formation mobility estimation faces challenges due to the dispersive nature of Stoneley waves and the susceptibility of Stoneley waves to various parameters. Ongoing efforts aim to refine methodologies, such as employing full Biot inversions, to estimate Stoneley-based formation mobility while accounting for parameters influencing Stoneley wave behavior. Parameters used for estimating Stoneley-based mobility include mud slowness, mud attenuation, mud density, pore fluid modulus, pre-fluid density, grain modulus, and membrane stiffness. While these parameters can be measured in boreholes or laboratories, membrane stiffness remains challenging to measure directly from borehole data or laboratory experiments.

Membrane stiffness is difficult to obtain physically due to conditions of the reservoir and the expense of the tools used to obtain the membrane stiffness. The tools to measure the mobility of the formation are only able to physically measure the mobility at certain points and depths in the formation. Current solutions are unable to provide continuous measurements of mobility due to the restrictions on locations where the tools are capable of physically measuring the mobility in the formation. Current solutions for obtaining the membrane stiffness and mobility are expensive and time consuming.

The present disclosure provides systems and methods for predicting membrane stiffness and providing a formation mobility estimation using acoustic Stoneley waves. Stoneley waves are a type of large-amplitude interface or surface wave generated by a sonic tool in a borehole. Stoneley waves can propagate along a solid-fluid interface, such as along the walls of a fluid-filled borehole and are the main low-frequency component of signals generated by sonic sources in boreholes. Analysis of Stoneley waves can allow estimation of the locations of fractures and permeability of the formation. The systems and methods use machine learning models for predicting membrane stiffness of a reservoir and estimating formation mobility using the predicted membrane stiffness and Stoneley waves. The systems and methods use the predicted membrane stiffness and mobility estimations to provide insights into reservoir properties and drilling conditions. The present disclosure includes a number of practical applications that provide benefits and/or solve problems associated with predicting membrane stiffness and providing a formation mobility estimation. Examples of these applications and benefits are discussed in further detail below.

One example benefit of the systems and methods of the present disclosure is accuracy in predicting mud cake membrane stiffness across a diverse range of borehole conditions, including variations in borehole size, mud types, formation compositions (carbonates and clastics), and fluid types (gas, oil, and water). By leveraging algorithms and vast datasets, the systems and methods address the longstanding challenge of physically measuring the membrane stiffness parameter, particularly in challenging carbonate reservoirs.

Another example benefit of the systems and methods of the present disclosure is offering unprecedented insights into reservoir properties and drilling conditions. By integrating a machine learning prediction model into formation mobility estimation workflows, the systems and methods provide a powerful tool for optimizing drilling strategies, aiding reservoir management decisions, and aiding resource exploration endeavors.

The methods and systems use machine learning models to estimate formation mobility using the predicted membrane stiffness and formation mobility. Mobility is the ratio of effective permeability to phase viscosity. The overall mobility is a sum of the individual phase viscosities. Well productivity is directly proportional to the product of the mobility and the layer thickness product.

One technical advantage of the systems and methods of the present disclosure is providing a continuous log of mobility of a formation. Another technical advantage of the systems and methods of the present disclosure is increasing an accuracy of the mobility and membrane stiffness estimations. Another technical advantage of the systems and methods of the present disclosure is using the continuous log of mobility to improve oil recovery and modify drilling strategies in a reservoir for proper well placement.

The system and methods estimate formation mobility using Stoneley waves, and predict mud cake membrane stiffness, providing advancements in reservoir analysis and exploration technologies.

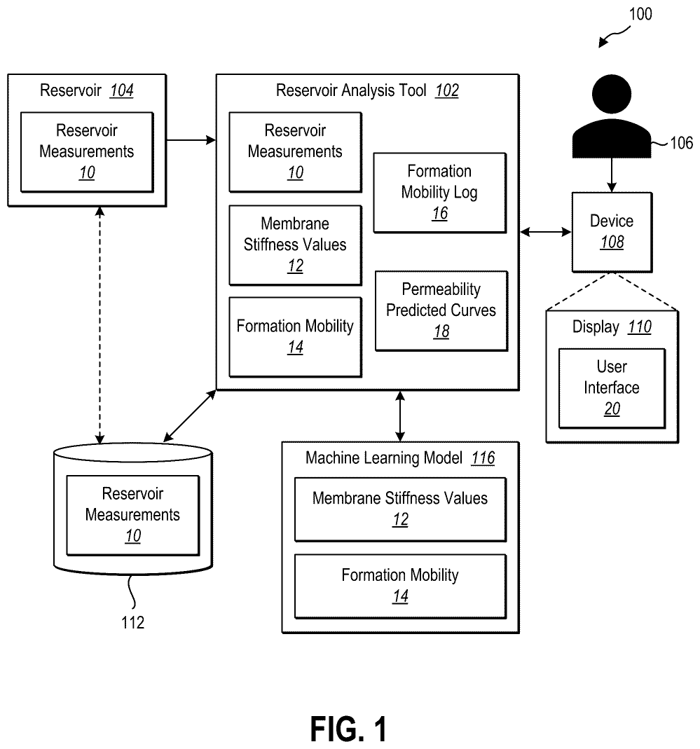

Referring now to FIG. 1, illustrated is an example environment 100 for predicting membrane stiffness and estimating formation mobility. The environment 100 includes a reservoir analysis tool 102 that a user 106 uses to evaluate a reservoir 104. The reservoir 104 is a subsurface body of rock having sufficient porosity and permeability to store and transmit fluids. One example of a reservoir 104 is sedimentary rocks. Sedimentary rocks have more porosity than most igneous and metamorphic rocks and form under temperature conditions at which hydrocarbons can be preserved. In some implementations, a well is drilled into the reservoir 104 from a surface location or seabed for various exploration and extraction activities. The wells are used to access and extract fluid resources like liquid and gaseous hydrocarbons from subterranean formations. For example, wellbores are constructed in the wells using of earth-boring equipment such as drill bits for initial drilling and reamers for enlarging the wellbore diameters.

The reservoir analysis tool 102 obtains reservoir measurements 10 from the reservoir 104. Tools at the reservoir 104 obtain the reservoir measurements 10. In some implementations, the tools are provided in a wellbore drilled through the subsurface formation of the reservoir 104 to obtain the reservoir measurements 10.

One example reservoir measurement 10 includes resistivity. Another example reservoir measurement 10 includes bulk density. Another example measurement includes neutron porosity. Another example reservoir measurement 10 includes gamma ray.

Another example reservoir measurement 10 includes a hole diameter. The hole diameter is determined using a caliper log combined with the sonic log, ensuring the selection of the engaged borehole, especially in cases of breakouts.

Another example reservoir measurement 10 includes compressional and shear slowness. Compressional and shear slowness are processed and integrated with bulk density logs, offering insights into formation properties and contributing data to the mobility inversion process.

Another example reservoir measurement 10 includes formation grain modulus and pore fluid modulus. The grain modulus at a depth in the reservoir 104 is determined from the dominant lithology identified. Stoneley, as a surface wave primarily reading the invaded zone, assumes the pore fluid as water, irrespective of the drilling fluid used.

Another example reservoir measurement 10 includes formation reservoir porosity. Another example reservoir measurement 10 includes mud density measured at the well site at the reservoir 104. For example, a drilling fluid engineer measures the mud density and includes the measurement in a drilling mud report. Another example reservoir measurement 10 includes mud slowness and attenuation. In some implementations, the mud slowness and attenuation are determined through a pre-evaluation step involving cross plots of apparent mud slowness and mud attenuation against porosity, colored by shale volume. The pre-evaluation step aids in establishing trends on the cross plot, assisting in the determination of required mud slowness and attenuation values.

Another example reservoir measurement 10 is mobility. Mobility is physically measured using tools at a set of points in the different depths of the reservoir 104. For example, a formation pressure testing tool is used at the reservoir 104 to measure formation mobility 14 of the reservoir 104. In some implementations, the mobility is measured across a variety of wells exhibiting different mud and borehole properties using the formation pressure testing tool.

In some implementations, tools at the reservoir 104 are in communication with the reservoir analysis tool 102 via a network. The network may include one or multiple networks and may use one or more communication platforms and/or technologies suitable for transmitting data. The network may refer to any data link that enables transport of electronic data between devices of the environment 100. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication.

While a single reservoir 104 is illustrated, the reservoir analysis tool 102 may be in communication with a plurality of reservoirs 104 and obtain the measurements from the plurality of reservoirs 104. The plurality of reservoirs 104 may provide diverse drilling environments (e.g., drilling environments exhibiting different mud and borehole properties).

In some implementations, the reservoir measurements 10 are provided to a datastore 112 from the plurality of reservoirs 104 via the network. The reservoir analysis tool 102 may obtain the reservoir measurements 10 from the datastore 112.

The reservoir analysis tool 102 uses the reservoir measurements 10 to predict the membrane stiffness values 12 of the reservoir 104 and estimate the formation mobility 14 of the reservoir 104. In some implementations, the reservoir analysis tool 102 uses one or more machine learning models 116 to predict the membrane stiffness values 12 and estimate the formation mobility 14. One example of the machine learning model 116 is a trained linear regression model. Another example of the machine learning model 116 is a trained deep neural network.

The reservoir analysis tool 102 provides the reservoir measurements 10 to the machine learning model 116 and the machine learning model uses the reservoir measurements 10 to predict the membrane stiffness values 12 of the reservoir 104. In some implementations, inputs to the machine learning model 116 include the reservoir measurements 10. For example, the reservoir measurements 10 include formation mobility testing and borehole attributes (e.g., porosity, density, drilling fluid type, hole size, compressional slowness, shale volume of the reservoir, and mud cake thickness).

In some implementations, the machine learning model 116 implements an algorithm to estimate the membrane stiffness values 12. The algorithm uses an inversion approach to establish a relationship between the membrane stiffness values 12 and Stoneley mobility. Stoneley mobility is the ability of fluid to move through a rock, as measured by the reduction in amplitude or increase in slowness of the acoustic Stoneley wave generated in the borehole. The algorithm analyzes the borehole attributes from the reservoir measurements 10 to identify a relationship between each attribute and the membrane stiffness. In some implementations, the borehole attributes include porosity, density, drilling fluid type, hole size, shale volume of the reservoir, compressional slowness, and mud cake thickness. The machine learning model 116 provides the estimated membrane stiffness values 12 to the reservoir analysis tool 102.

The machine learning model 116 uses the estimated membrane stiffness values 12 in predicting the formation mobility 14 of the reservoir 104 at locations at different depths in the reservoir 104. Using the predicted mud cake membrane stiffness values 12 in predicting the formation mobility 14 improves the accuracy of the Stoneley mobility estimations. The machine learning model 116 provides the predicted formation mobility 14 to the reservoir analysis tool 102. The reservoir analysis tool 102 uses the formation mobility 14 output by the machine learning model 116 to generate a formation mobility log 16 with continuous formation mobility 14 estimations for the different locations within the reservoir 104 at different depths.

In some implementations, the reservoir analysis tool 102 uses the estimated membrane stiffness values 12 and the formation mobility log 16 to generate permeability predicted curves 18 with reservoir characterizations of the reservoir 104. The membrane stiffness values 12, the formation mobility log 16, and the permeability predicted curves 18 provide insights into the reservoir properties and drilling conditions of the reservoir 104. For example, the membrane stiffness values 12, the formation mobility log 16, and the permeability predicted curves 18 may identify production zones within the reservoir 104 where hydrocarbons are located and drilling may be successful. Another example includes the membrane stiffness values 12, the formation mobility log 16, and the permeability predicted curves 18 identifying areas within the reservoir 104 where hydrocarbons are missing in the reservoir 104 and where drilling may be unsuccessful.

In some implementations, the estimated membrane stiffness values 12, the formation mobility log 16, and the permeability predicted curves 18 are provided by the reservoir analysis tool 102 to other applications for downstream tasks or further processing.

In some implementations, the estimated membrane stiffness values 12, the formation mobility log 16, and the permeability predicted curves 18 are provided on a user interface 20 to a user 106. The user 106 accesses the reservoir analysis tool 102 using a device 108. In some implementations, the reservoir analysis tool 102 is on a cloud server remote from the device 108 of the user 106 and is accessed through the network. The reservoir analysis tool 102 is hosted on virtual machines in the cloud. In some implementations, the reservoir analysis tool 102 is on an edge device accessed by the device 108 of the user 106 through the network. For example, a uniform resource locator (URL) configured to an end point of the reservoir analysis tool 102 is provided to the device 108 that the user 106 may access using a browser on the device 108. Another example includes an application on the device 108 of the user 106 providing access to the reservoir analysis tool 102.

The reservoir analysis tool 102 may cause the membrane stiffness values 12, the formation mobility log 16, and/or the permeability predicted curves 18 to be presented on a user interface 20 of a display 110 of the device 108. In some implementations, the user 106 uses the membrane stiffness values 12, the formation mobility log 16, and/or the permeability predicted curves 18 to modify drilling strategies for proper well placement. For example, the user 106 changes a direction of drilling in the reservoir 104 in response to the values of the membrane stiffness values 12, the formation mobility log 16, and/or the permeability predicted curves 18. The permeability predicted curves 18 enable precise production optimization and improved oil recovery.

In some implementations, the user 106 uses the membrane stiffness values 12, the formation mobility log 16, and/or the permeability predicted curves 18 in reservoir management decisions. For example, the user 106 determines to continue drilling in the reservoir 104 in response to the values of the membrane stiffness values 12, the formation mobility log 16, and/or the permeability predicted curves 18. Another example includes the user 106 deciding to suspend drilling in the reservoir 104 in response to the values of the membrane stiffness values 12, the formation mobility log 16, and/or the permeability predicted curves 18. In some implementations, the user 106 uses the membrane stiffness values 12, the formation mobility log 16, and/or the permeability predicted curves 18 in resource exploration endeavors.

The environment 100 facilitates the realization of enhanced hydrocarbon extraction efficiency across diverse oil and gas fields. The environment 100 provides an efficient and accurate means of estimating membrane stiffness values 12 in various drilling scenarios, thereby enhancing understanding and optimization of drilling operations as well as field development plans in both brownfields and greenfields. The environment 100 estimates formation mobility 14 using Acoustic Stoneley waves generating a continuous formation mobility log 16 of the reservoir 104 that can be used to enhance reservoir characterizations and exploration methodologies.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the reservoir analysis tool 102, the machine learning model 116, and the datastore 112 are implemented on a single computing device. Moreover, in some implementations, one or more subcomponent of the feature and functionalities discussed herein may be implemented or processed on different server devices of the same or different cloud computing networks. For example, the reservoir analysis tool 102, the machine learning model 116, and the datastore 112 are implemented on different server devices. In this way, the environment 100 may be a cloud computing environment, and the reservoir analysis tool 102 and/or the machine learning model 116 may be implemented across one or more devices of the cloud computing environment in order to leverage the processing capabilities, memory capabilities, connectivity, speed, etc., that such cloud computing environments offer in order to facilitate the features and functionalities described herein.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

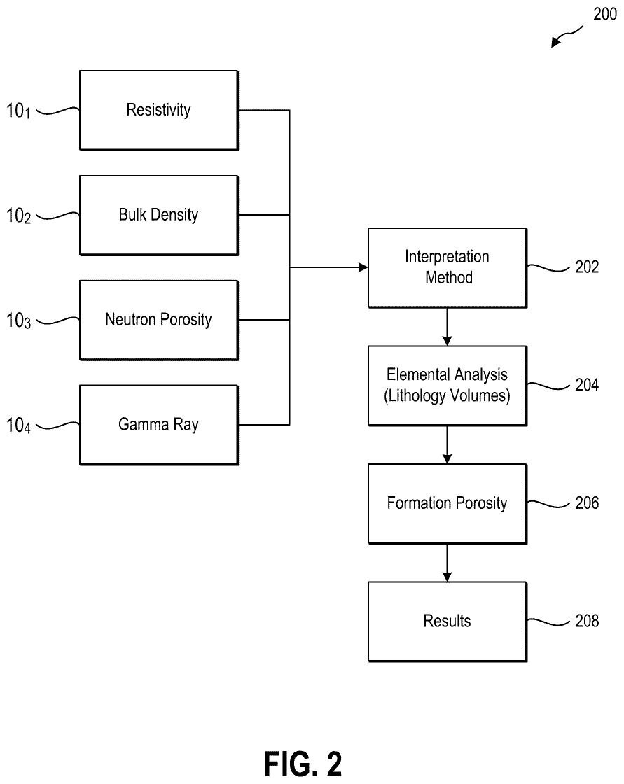

FIG. 2 illustrates an example method 200 of processing reservoir measurements 10 (FIG. 1). The actions of the method 200 are discussed below in reference to the architecture of FIG. 1. In some implementations, an equation solver with predefined constraints performs the actions of the method 200. In some implementations, the reservoir analysis tool 102 includes the equation solver. In some implementations, the reservoir analysis tool 102 obtains the results from the equation solver.

At 202, the method 200 includes employing an interpretation method on various open hole logs. For example, the equation solver performs the interpretation method on the various open hole logs (e.g., resistivity 10₁, bulk density 10₂, gamma ray 10₃, and epithermal neutron porosity 10₄) obtained from the reservoir measurements 10.

At 204, the method 200 includes performing elemental analysis (lithology volumes), and at 206, the method 200 includes determining formation porosity. For example, the equation solver performs the elemental analysis on the various open hole logs and determines the formation porosity. The open hole logs collectively contribute to the computation of reservoir porosity and the determination of lithology within the reservoir.

At 208, the method 200 includes outputting the results. For example, the equation solver outputs the results to the reservoir analysis tool 102. The integration of the log measurements results in the creation of a robust elemental analysis model.

The method 200 incorporates various open-hole logs from the reservoir measurements 10 to compute reservoir porosity and lithology determinations. The reservoir analysis tool 102 uses the reservoir porosity and lithology determinations in predicting the membrane stiffness values 12 and the formation mobility 14 of the reservoir 104.

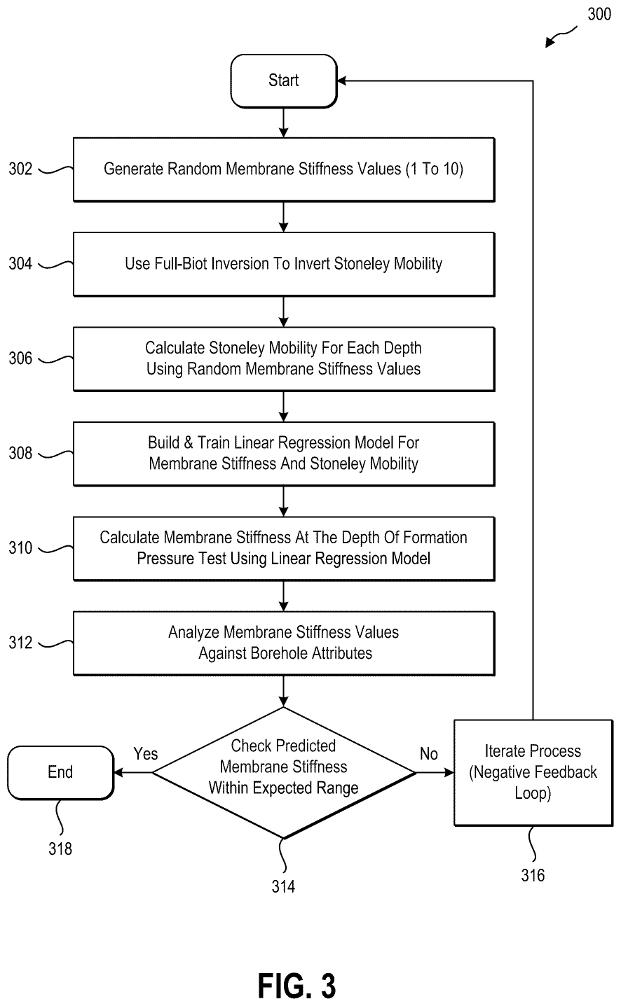

FIG. 3 illustrates an example method 300 for predicting membrane stiffness. The actions of the method 300 are discussed below in relation to FIGS. 1 and 2. In some implementations, the reservoir analysis tool 102 uses one or more machine learning models 116 to implement the method 300.

At 302, the method 300 includes generating random membrane stiffness values. A pre-defined number of membrane stiffness values are randomly generated by the machine learning model 116 within the expected range of 1 to 10. In some implementations, the generation occurs across a variety of wells exhibiting different mud and borehole properties, with mobility estimated from the formation pressure testing tool.

At 304, the method 300 includes using the generated random membrane stiffness values in a full-Biot inversion method to derive Stoneley mobility. The machine learning model 116 applies the generated random membrane stiffness values in the full-Biot inversion method to derive Stoneley mobility. In some implementations, the machine learning model 116 applies a Stoneley mobility inversion workflow integrating parameters such as hole diameter, compressional and shear slowness, formation grain modulus, pore fluid modulus, formation reservoir porosity, mud density, mud slowness, and attenuation to derive the Stoneley mobility.

At 306, the method 300 includes calculating Stoneley mobility for each depth using the random membrane stiffness values. In some implementations, the Stoneley mobility is calculated using the Full-Biot method. In some implementations, the random membrane stiffness values are provided to the machine learning model 116. The machine learning model 116 uses the randomly generated membrane stiffness values to output the Stoneley mobility for each sample point within a well (depth reference). In some implementations, the machine learning model 116 receives ten random membrane stiffness values for a depth reference and outputs ten Stoneley mobilities for the depth reference using the random membrane stiffness.

At 308, the method 300 includes training a machine learning model for membrane stiffness and Stoneley mobility. In some implementations, the calculated Stoneley mobilities are used to train the machine learning model 116. In some implementations, the machine learning model 116 is a linear regression model that is constructed and trained for each sample point within a given well to establish a relationship between the membrane stiffness and the Stoneley mobility. During the training, borehole attributes at each sample point, such as, porosity, compressional slowness, shale volume, etc., are considered.

At 310, the method 300 includes calculating, using the trained machine learning model, membrane stiffness values. At the depth of each formation pressure test, a new membrane stiffness value is calculated using the trained machine learning model 116 specific to that depth. In some implementations, the inputs to the trained linear regression model include borehole attributes and formation mobility testing.

At 312, the method 300 includes analyzing calculated membrane stiffness values. The machine learning model 116 analyzes the calculated membrane stiffness values compared to the borehole attributes to identify the relationship between each borehole attribute and the calculated membrane stiffness values. In some implementations, the borehole attributes include porosity, drilling fluid type, hole size, and mud cake thickness.

At 314, the method 300 includes verifying that the calculated membrane stiffness values is within an expected range. The machine learning model 116 compares the calculated membrane stiffness values to an expected range. In some implementations, the expected range is 1 to 10.

At 316, the method 300 includes returning to 302 in response to determining that the calculated membrane stiffness values are outside the expected range. The machine learning model 116 returns to 302 and generates random membrane stiffness values and re-starts the method 300 in response to determining that the calculated membrane stiffness values are outside of the expected range (e.g., exceeds 10 or below 1).

At 318, the method 300 includes outputting the calculated membrane stiffness values as the predicted membrane stiffness values in response to determining that the calculated membrane stiffness values are within the expected range. The machine learning model 116 outputs the calculated membrane stiffness values as the predicted membrane stiffness values 12 in response to determining that the calculated membrane stiffness values are within the expected range (e.g., within 1 to 10).

The method 300 provides an efficient and accurate estimation of membrane stiffness values 12 in various drilling scenarios, thereby enhancing understanding and optimization of drilling operations as well as field development plans in both brownfields and greenfields.

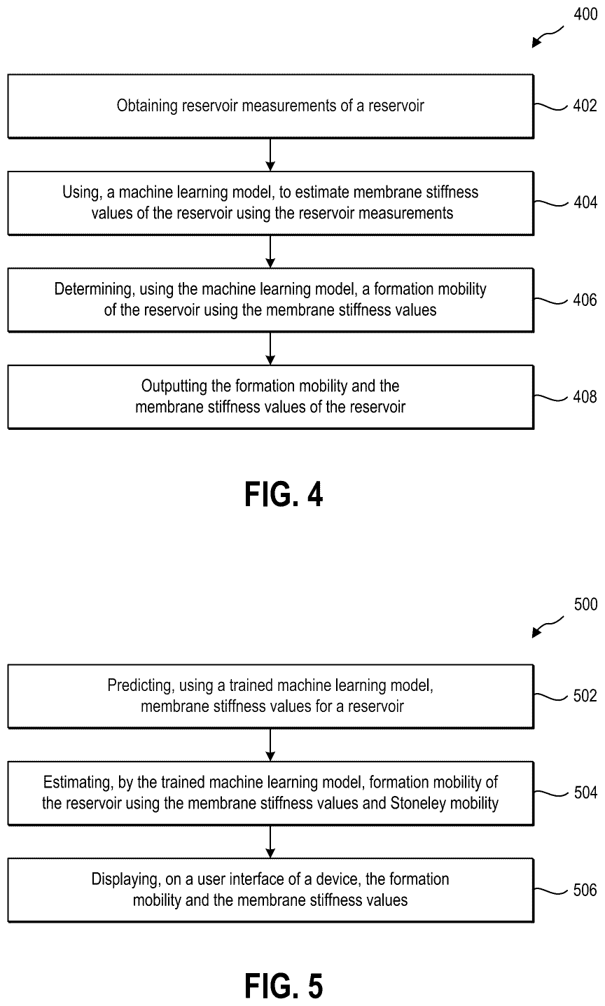

FIG. 4 illustrates an example method 400 for predicting membrane stiffness and estimating formation mobility. The actions of the method 400 are discussed below in relation to FIGS. 1-3.

At 402, the method 400 includes obtaining reservoir measurements of a reservoir. The reservoir analysis tool 102 obtains the reservoir measurements 10 of a reservoir 104. In some implementations, the reservoir measurements 10 include a reservoir porosity and lithology determination. In some implementations, the reservoir measurements 10 include hole diameter, compressional and shear slowness, formation grain modulus, pore fluid modulus, formation reservoir porosity, mud density, mud slowness, attenuation, formation testing mobility data, and Stoneley waves. In some implementations, the reservoir measurements are borehole attributes.

At 404, the method 400 includes using a machine learning model to estimate membrane stiffness values of the reservoir using the reservoir measurements. In some implementations, the reservoir analysis tool 102 uses a machine learning model 116 to estimate the membrane stiffness values 12 of the reservoir 104 using the reservoir measurements 10.

In some implementations, the machine learning model 116 estimates the membrane stiffness values 12 by randomly generating membrane stiffness values; using the randomly generated membrane stiffness values in an inversion method; calculating Stoneley mobilities using the randomly generated membrane stiffness values; calculating new membrane stiffness values by inverting the randomly generated membrane stiffness values from formation testing mobility data; analyzing the calculated membrane stiffness values with the reservoir measurements; and outputting the calculated membrane stiffness values as the estimated membrane stiffness values.

In some implementations, the machine learning model 116 analyzes the calculated membrane stiffness values by comparing the calculated membrane stiffness values to borehole attributes of the reservoir 104 identifying the relationship between the borehole attributes and the membrane stiffness. For example, the borehole attributes include formation reservoir porosity, compressional slowness, and shale volume of the reservoir. In some implementations, the machine learning model 116 verifies the calculated membrane stiffness values are within the expected range (e.g., 1 to 10).

At 406, the method 400 includes determining, using the machine learning model, a formation mobility of the reservoir using the membrane stiffness values. In some implementations, the reservoir analysis tool 102 uses a machine learning model 116 to predict the formation mobility 14 of the reservoir 104 using the reservoir measurements 10. In some implementations, the machine learning model 116 performs a Stoneley mobility inversion workflow integrating formation mobility measured at the reservoir 104 and the reservoir measurements 10 to determine the formation mobility 14.

At 408, the method 400 includes outputting the formation mobility and the membrane stiffness values of the reservoir. In some implementations, the reservoir analysis tool 102 outputs the formation mobility 14 and the membrane stiffness values 12 on a user interface 20 of a display 110. In some implementations, the reservoir analysis tool 102 outputs the formation mobility 14 as a formation mobility log 16 with a set of continuous formation mobilities for different depths of the reservoir 104.

In some implementations, the reservoir analysis tool 102 uses the formation mobility 14 and the membrane stiffness values 12 to identify production zones in the reservoir 104 where hydrocarbons are located and outputs the production zones. In some implementations, the reservoir analysis tool 102 generates a permeability predicted curve of the reservoir 104 using the formation mobility 14 and the membrane stiffness values 12 and outputs the permeability predicted curve.

The method 400 provides accurate estimations of membrane stiffness values in the reservoir and accurate estimations of the formation mobility in diverse drilling environments.

FIG. 5 illustrates an example method 500 for evaluating formation properties. The actions of the method 500 are discussed below in relation to FIGS. 1-4.

At 502, the method 500 includes predicting, using a trained machine learning model, membrane stiffness values for a reservoir. The reservoir analysis tool 102 uses a trained machine learning model 116 to predict the membrane stiffness values 12 for the reservoir 104. In some implementations, the machine learning model 116 is trained with inputs from different drilling environments. In some implementations, the trained machine learning model 116 is a linear regression model trained using borehole attributes and formation mobility as inputs. For example, the borehole attributes include formation reservoir porosity, compressional slowness, and shale volume of the reservoir.

At 504, the method 500 includes estimating, by the trained machine learning model, formation mobility of the reservoir using the membrane stiffness values and Stoneley mobility. The reservoir analysis tool 102 uses a trained machine learning model 116 to estimate the formation mobility 14 for the reservoir 104 using the membrane stiffness values 12 and the Stoneley mobility.

At 506, the method 500 includes displaying, on a user interface of a device, the formation mobility and the membrane stiffness values. The reservoir analysis tool 102 displays on a user interface 20 of a device 108 of a user 106 the formation mobility 14 and the membrane stiffness values 12.

In some implementations, the reservoir analysis tool 102 uses the formation mobility 14 and the membrane stiffness values 12 to identify production zones in the reservoir 104 where hydrocarbons are located and causes modifications to drilling occurring in the reservoir 104 in response to identifying the production zones. For example, the reservoir analysis tool 102 automatically changes a direction of a drill bit in the reservoir 104 to a different location in the reservoir in response to identifying the production zones. In some implementations, the reservoir analysis tool 102 recommends moving the drilling to a different location in the reservoir 104.

In some implementations, the reservoir analysis tool 102 uses the formation mobility 14 and the membrane stiffness values 12 to characterize the reservoir 104 and the reservoir analysis tool 102 modifies the oil recovery process in response to the characterization of the reservoir 104. For example, the reservoir analysis tool 102 provides a recommendation to discontinue drilling in the reservoir 104 in response to the characterization of the reservoir 104. Another example includes the reservoir analysis tool 102 providing a recommendation to modify a drilling location in the reservoir 104 in response to the characterization of the reservoir 104.

The method 500 enhances the decision-making process of reservoir management and facilitates the realization of enhanced hydrocarbon extraction efficiency across diverse oil and gas fields. The method 500 provides improved oil recovery strategies for a reservoir 104 by providing the predicted membrane stiffness values 12 and the estimated formation mobility 14. The method 500 provides enhanced reservoir characterizations with the predicted membrane stiffness values 12 and the estimated formation mobility 14.

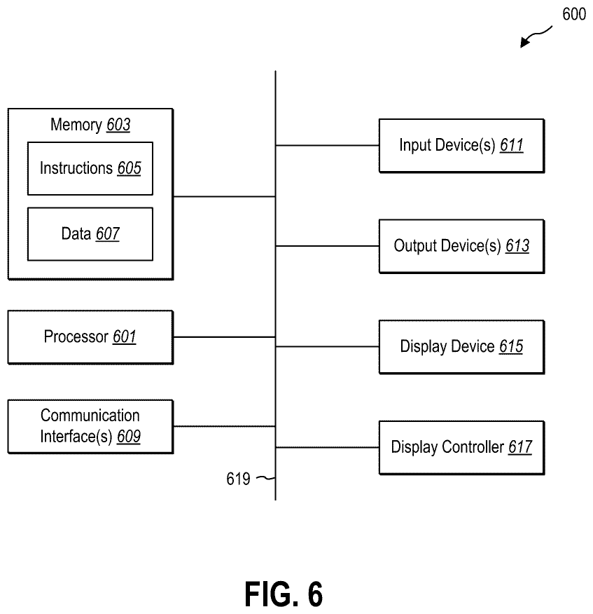

FIG. 6 illustrates components that may be included within a computer system 600. One or more computer systems 600 may be used to implement the various methods, devices, components, and/or systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and light pen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

In some implementations, the various components of the computer system 600 are implemented as one device. For example, the various components of the computer system 600 are implemented in a mobile phone or tablet. Another example includes the various components of the computer system 600 implemented in a personal computer. Another example includes the various components of the computer system 600 implemented in the cloud. Another example includes the various components of the computer system 600 implemented on an edge device.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. There is no intention to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A system comprising:
a memory to store data and instructions; and
a processor operable to communicate with the memory, wherein the processor is operable to:
obtain reservoir measurements of a reservoir;
use, a machine learning model, to estimate membrane stiffness values of the reservoir using the reservoir measurements;
determine, using the machine learning model, a formation mobility of the reservoir using the membrane stiffness values; and
output the formation mobility and the membrane stiffness values of the reservoir.

2. The system of claim 1, wherein the reservoir measurements include a reservoir porosity and lithology determination.

3. The system of claim 1, wherein the reservoir measurements include hole diameter, compressional and shear slowness, formation grain modulus, pore fluid modulus, formation reservoir porosity, mud density, mud slowness, attenuation, formation testing mobility data, and Stoneley waves.

4. The system of claim 1, wherein the processor is further operable to use the machine learning model to perform a Stoneley mobility inversion workflow integrating formation mobility measured at the reservoir and the reservoir measurements to determine the formation mobility.

5. The system of claim 1, wherein the processor is further operable to use the machine learning model to estimate the membrane stiffness values by:
randomly generating membrane stiffness values;
using the randomly generated membrane stiffness values in an inversion method;
calculating Stoneley mobilities using the randomly generated membrane stiffness values;
calculating new membrane stiffness values by inverting the randomly generated membrane stiffness values from formation testing mobility data;
analyzing the calculated membrane stiffness values with the reservoir measurements; and
outputting the calculated membrane stiffness values as the estimated membrane stiffness values.

6. The system of claim 5, wherein the reservoir measurements are borehole attributes.

7. The system of claim 1, wherein the processor is further operable to output the formation mobility as a formation mobility log with a set of formation mobilities for different depths of the reservoir.

8. The system of claim 1, wherein the processor is further operable to:
use the formation mobility and the membrane stiffness values to identify production zones in the reservoir where hydrocarbons are located; and
output the production zones in the reservoir.

9. The system of claim 1, wherein the processor is further operable to:
generate a permeability predicted curve of the reservoir using the formation mobility and the membrane stiffness values; and
output the permeability predicted curve.

10. A method comprising:
generating sets of Stoneley mobilities using randomly generated membrane stiffness values within an expected range;
training a machine learning model for each sample point within a reservoir to establish a relationship between the membrane stiffness values and Stoneley mobilities;
calculating, using the trained machine learning model, new membrane stiffness values at a depth for each formation pressure test that obtained the Stoneley mobilities;
inverting, using the trained machine learning model, the membrane stiffness values from the Stoneley mobilities; and
outputting the membrane stiffness values.

11. The method of claim 10, further comprising:
analyzing, using the trained machine learning model, calculated membrane stiffness values by comparing the calculated membrane stiffness values to borehole attributes of the reservoir identifying the relationship between the borehole attributes and the membrane stiffness.

12. The method of claim 11, wherein the borehole attributes include formation reservoir porosity, compressional slowness, and shale volume of the reservoir.

13. The method of claim 11, further comprising:
verifying, using the trained machine learning model, the calculated membrane stiffness values are withing the expected range.

14. The method of claim 11, wherein the trained machine learning model is a linear regression model trained using borehole attributes and formation mobility as inputs.

15. The method of claim 11, wherein the trained machine learning model is trained with inputs from different drilling environments.

16. The method of claim 11, wherein the membrane stiffness values are randomly generated across a variety of reservoirs exhibiting different mud and borehole properties.

17. A method comprising:
predicting, using a trained machine learning model, membrane stiffness values for a reservoir;
estimating, by the trained machine learning model, formation mobility of the reservoir using the membrane stiffness values and Stoneley mobility; and
displaying, on a user interface of a device, the formation mobility and the membrane stiffness values.

18. The method of claim 17, further comprising:
using the formation mobility and the membrane stiffness values to identify production zones in the reservoir where hydrocarbons are located; and
causing modifications to drilling occurring in the reservoir in response to identifying the production zones.

19. The method of claim 18, wherein a modification to the drilling includes changing a direction of a drill bit in the reservoir or moving to a different location in the reservoir.

20. The method of claim 17, further comprising:
using the formation mobility and the membrane stiffness values to characterize the reservoir; and
modifying oil recovery processes in response to characterization of the reservoir.
